(19) United States
(12) Patent Application Publication
(10) Pub. No.: US 2006/0120697 A1
(43) Pub. Date: Jun. 8, 2006

(54) Simultaneous audio and visual content download and playback

(76) Inventors: Gabriel Beged-Dov, Corvallis, OR (US); Joe McCrossan, Burbank, CA (US); Tomoyuki Okada, Tomio-motomachi (JP); Philip M. Walker, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/005,173

(22) Filed: Dec. 6, 2004

(51) Int. Cl. H04N 5/781

(52) U.S. Cl. 386/125

(57) ABSTRACT

A method for audio and visual content download and playback includes downloading a clip that includes audio and visual content from a web site. It is contemplated the clip has been segmented into a plurality of smaller clips. The method continues with storing the metadata for the plurality of smaller clips in a local storage and initiating playback of the plurality of smaller clips. The method also includes displaying the content of a first of the plurality of smaller clips while a second of the plurality of smaller clips is being downloaded.

### BACKGROUND OF THE INVENTION

In a system that plays audio and visual content stored on optical discs, such as a home entertainment system, there is an occasional need to update content that is complementary to the content stored on the disc. An example of this can be found in the BD-ROM Audio Visual Application Format Specifications, where a “coming attractions” section could be provided prior to the beginning of a feature-length movie. When the BD-ROM disc is purchased, all content present on the disc is static, and is thus not updatable. Therefore, the “coming attractions” section may reflect movies that have already been released by the time the customer buys or rents the disc. In some cases, the viewer has already seen the movie associated with the “coming attractions” movie trailer. This renders the “coming attractions” section of the disc almost useless.

In next generation entertainment systems, an Internet connection will likely be provided. This permits content items such as the “coming attractions”, to be updated on an occasional or regular basis. Thus, the viewer can remain apprised of the new movies being released by the various movie studios and other content providers. This capability also benefits the movie studios and other content providers since they now have a vehicle that allows them to communicate new attractions to a target audience.

However, in many homes there is not sufficient bandwidth to transfer the entire content item to the home in a timely manner. Thus, the user may be faced with a scenario where he or she must wait for several minutes, or longer, while audio and video content is conveyed from the studio web site to the user's home. This diminishes the appeal of providing updated movie trailers to interested audiences.

### BRIEF DESCRIPTIONS OF DRAWINGS

FIG. 1 is a system for simultaneous audio and visual content presentation and download according to an embodiment of the invention.

FIG. 2 is a flowchart for a method of audio and visual content download and playback according to a first embodiment of the invention.

FIG. 3 is a flowchart for a method for audio and visual content download and playback according to a second embodiment of the invention.

FIG. 4 is a flowchart for a method for simultaneous content download and playback according to a third of the invention.

### BRIEF DESCRIPTION OF THE APPENDIX

The attached Appendix, entitled “White Paper—Blu-ray Disc Read Only Disc Format Part 3 Audio Visual Application Specifications” has been included to provide a deeper understanding of at least some of the terms used herein. The terms “playlist”, “play item”, and “clip information” are described in Section 2.1 of the Appendix.

### DESCRIPTION OF THE EMBODIMENTS

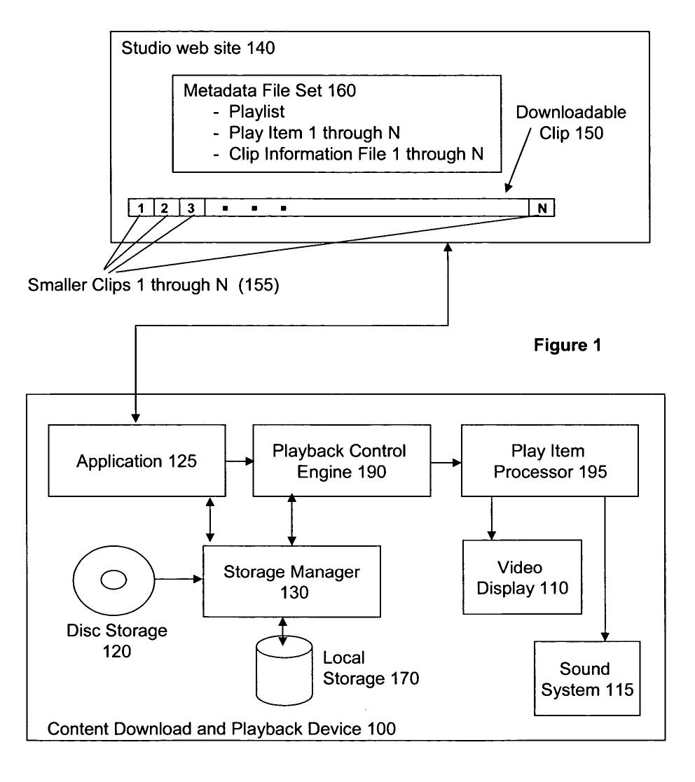

FIG. 1 is a system for simultaneous audio and visual content presentation and download according to an embodiment of the invention. In FIG. 1, content download and playback device 100 is an entertainment device that presents audio and visual information to a user by way of video display 110 and sound system 115. Playback device 100 includes disc storage 120, which may be an optical storage media similar to a conventional DVD. However, in the context of the present invention, disc storage 120 is designed to respond to a 405 nm (“Blu-Ray”) laser that provides higher density storage than conventional DVDs. Thus, disc storage 120 may support higher definition video, as opposed to standard definition video provided by conventional DVD recording and playback systems.

As previously mentioned, FIG. 1 corresponds to an entertainment device that presents audio and visual information to a user. In one embodiment, the entertainment device is used to play movies that might be rented or bought through a video rental service or other distribution channel. Occasionally, perhaps prior to the start of a feature length movie, the user may wish to view “coming attractions” or other information that complements the particular movie stored on disc storage 120. In the embodiment of FIG. 1, additional information can be updated so as to provide the user with the most recent movie previews provided by the studio or other disc provider.

When the user decides that he or she wishes to update movie trailer or other information that might complement the movie stored on disc storage 120, the user interacts with application 125. In other embodiments, interaction with application 125 may be initiated by a set of commands stored on disc storage 120. In either case, in response to an input (perhaps along with other inputs that may include identifying information from disc storage 120) application 125 contacts studio web site 140 and informs the web site of the desire to download and view updated movie trailers. Although it is contemplated that this communication occurs by way of a network interface to the Internet, nothing prevents communication by other means.

In response to the query from application 125, studio web site 140 identifies downloadable clip 150 as being available for download to content download and playback device 100. It is contemplated that downloadable clip 150 represents a significantly-sized data file, perhaps on the order of 500 megabytes or more. However in other embodiments of the invention, downloadable clip 150 may represent a data file of a lesser or greater size. An example of downloadable clip 150 may be a movie trailer lasting for a couple of minutes or perhaps may be a somewhat larger file consisting of 30-minute interview with the director of a particular movie. In another example, downloadable clip 150 represents the entire audio portion of a feature-length movie in a language not supported in the original release of disc storage 120. In the embodiment of FIG. 1, metadata file set 160 is also present at studio web site 140 and is envisioned as including descriptive information about downloadable clip 150 and likely represents much smaller file sizes, perhaps on the order of 20 kilobytes or less.

When studio web site 140 makes downloadable clip 150 available to various users, such as the user of content download and playback device 100, it is contemplated that the downloadable clip has been segmented into smaller clips 1 through N (155). In the embodiment of FIG. 1, N is a number between 10 and 30. However in other embodiments, N may be as small as two or larger than 100. Metadata file set 160 includes playlist information, as well as “play item” information and a clip information file for each of smaller clips 1 through N.

When application 125 and studio web site 140 initiate downloading, the process begins with studio web site 140 transmitting metadata file set 160 to application 125. Upon receipt of metadata file set 160, application 125 conveys the metadata file set to storage manager 130 which populates local storage 170 with a representation of metadata file set 160. In the embodiment of FIG. 1, storage manager 130 arranges metadata file set 160 in a manner that accords with the arrangement of metadata that pertains to the playlist, play items, and clip information files of the audio and visual content present on disc storage 120. This allows playback control engine 190, which is responsible for accessing all audio and visual clips and presenting these to the user, to be unconcerned with the physical location of the particular audio and visual clip. In other words, in the embodiment of FIG. 1, all audio and visual clips, including those that may have been recently downloaded from studio web site 140, as well as those stored by way of disc storage 120, appear as an identical file type in a “virtual view” that is presented to playback control engine 190. It is contemplated that the arrangement of metadata file set 160 by local storage manager 130 occurs prior to the download of any of smaller clips 1 through N (155).

In the architecture of FIG. 1, when a particular one of smaller clips 1 through N (155) has been completely downloaded and stored in local storage 170, storage manager 130 makes the clip available to playback control engine 190. This allows playback control engine 190 to access the clip and play the clip by way of play item processor 195. While the smaller clip is being played (that is, the content of the smaller clip is being presented to the user by way of video display 110 and sound system 115) the next one of smaller clips 1 through N (155) can be downloaded. Consequently, when the next one of smaller clips 155 has been downloaded, this smaller clip is made available to playback control engine 190 and play item processor 195 for display to the user. In this way, the user is able to watch additional content that might complement content stored on disc storage 120 without having to wait for the entire downloadable clip (150) to download. Further, the additional content, although downloaded in piecemeal fashion, can be seamlessly presented to the user. In other words, the user need not be made aware that the downloadable clip (150) has been segments and reassembled by playback control engine 190.

In the event that the user selects to jump or “fast forward” to another location in the downloadable clip (150), the playback control engine 190 receives this command. Playback control engine 190 then searches for the smaller clip corresponding to the requested portion of the content. In the event that the desired smaller clip is not available, playback control engine 190 signals an error to application 125 indicating that the requested smaller clip is not accessible by way of storage manager 130. Application 125 then signals to studio web site 140 to initiate the download the desired smaller clip. In this event, application 125 may also display an indication on video display 110 (such as an hourglass icon) that informs the user that a requested clip is not accessible and is being currently downloaded.

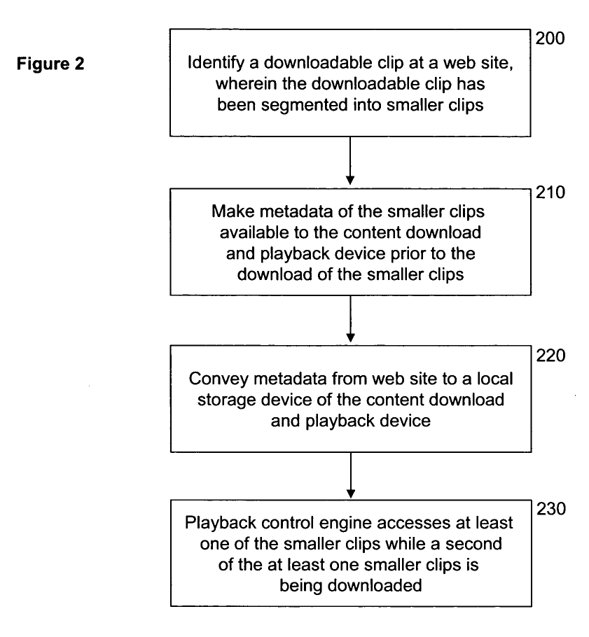

FIG. 2 is a flowchart for a method of audio and visual content download and playback according to a first embodiment of the invention. The system of FIG. 1 is suitable for performing the method of FIG. 2. At step 200, a downloadable clip is identified as being present at a web site, such as a studio or other content provider's web site. In the embodiment of FIG. 2, the downloadable clip has been previously segmented into a collection of smaller clips. At step 210, a download of the smaller clips is initiated by the web site and the content download and playback device. Step 210 includes making the metadata of the smaller clips available to the content download and playback device prior to the download of any of the smaller clips. At step 220, metadata information is conveyed from the web site to the content download and playback device. Step 220 also includes the metadata being conveyed to local storage within the content download and playback device. At step 230, the playback control engine accesses at least one of the smaller clips downloaded from the web site. In step 230, the access occurs while a second one of the smaller clips is being downloaded from the web site.

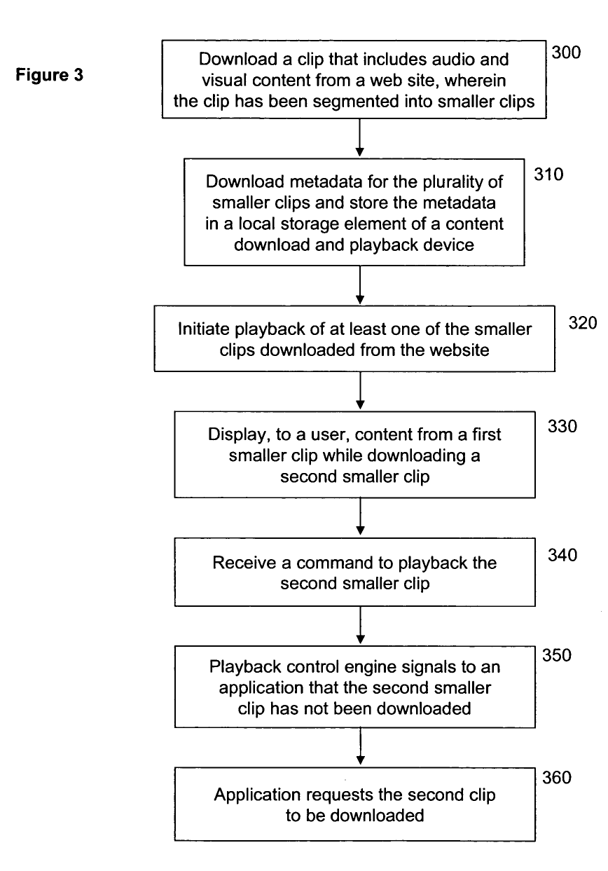

FIG. 3 is a flowchart for a method for audio and visual content download and playback according to a second embodiment of the invention. The system of FIG. 1 is suitable for performing the method of FIG. 3. At step 300, a clip that includes audio and visual content from a web site is downloaded to the content and playback device. The clip of step 300 is contemplated as having been previously segmented into a plurality of smaller clips. At step 310, downloaded metadata for the plurality of smaller clips is stored in a local storage element of a content download and playback device. (In some embodiments of the invention, step 310 may be performed prior to performing step 300.) The method continues at step 320 which includes initiating playback of at least one of the smaller clips downloaded from the web site. Step 330 includes displaying, to a user, content from a first of the smaller clips while a second of the smaller clips is being downloaded.

At step 340, a playback control engine of the content download and playback device receives a command to playback the second smaller clip. At step 350, the playback control engine signals to an application that the second of smaller clip is currently not accessible. At step 360, the application requests the second clip be downloaded from the web site.

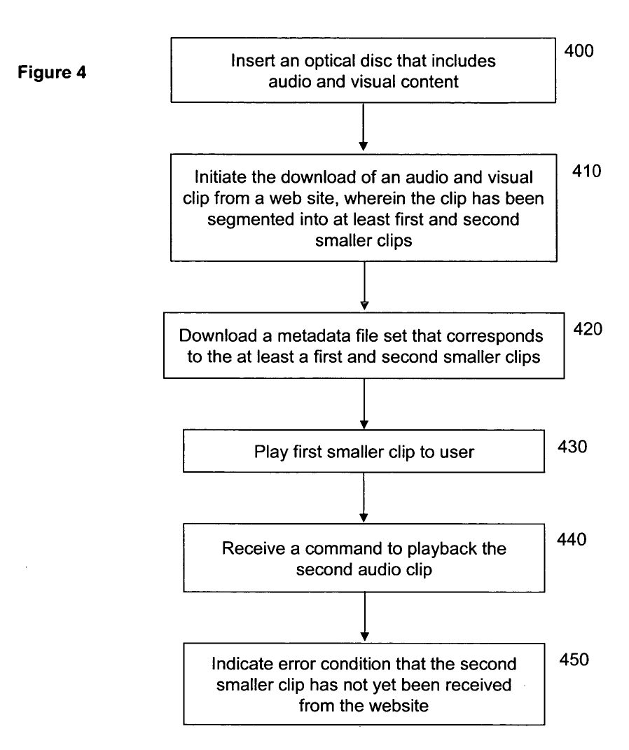

FIG. 4 is a flowchart for a method for simultaneous content download and playback according to a third embodiment of the invention. The system of FIG. 1 is suitable for performing the method of FIG. 4. The method begins at step 400 in which a user inserts an optical disc that includes audio and visual content. At step 410, an application initiates the download of an audio and visual clip from a web site. The audio and visual clip may perhaps be complementary to the movie or other content present on the optical disc. It is contemplated that the audio and visual clip at the web site has already been segmented into at least a first and second smaller audio and visual clips. At step 420, metadata corresponding to both the first and second smaller clips is downloaded. At step 430, the content download and playback system plays the first smaller audio and visual clip to the user.

Concurrently with the playback of the first clip, the second audio and visual clip is downloaded from the web site. At step 440, a command from the application to playback the second smaller clip is received. Step 450 includes indicating to the application that the second smaller clip has not yet been received from a web site. Step 450 thus represents an error condition in which a particular clip has been requested but that the clip it is not yet available.

In conclusion, while the present invention has been particularly shown and described with reference to various embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

What is claimed is:

1. A method for audio and visual content download and playback, comprising:
identifying a downloadable clip at a web site, the downloadable clip being segmented into a plurality of smaller clips;
initiating a download of the plurality of smaller clips;
conveying metadata information of the plurality of smaller clips to local storage in a content download and playback device; and
a playback control engine accessing at least one of the plurality of smaller clips while at least one of the plurality of smaller clips is being downloaded to the content download and playback device.

2. The method of claim 1, wherein the initiating step includes making the metadata information of the plurality of smaller clips available to the content download and playback device.

3. The method of claim 1, wherein the metadata information of plurality of smaller clips includes a single playlist, a play item corresponding to each of the plurality of smaller clips, and a clip information file corresponding to each of the plurality of smaller clips.

4. The method of claim 1, additionally comprising:
the playback control engine receiving a command to playback a second one of the plurality of smaller clips; and
the playback control engine detecting that the content of the second one of the plurality of smaller clips is not accessible.

5. The method of claim 4, further comprising the playback control engine signaling that an error has occurred.

6. The method of claim 5 wherein an application produces an indication to the user that an error condition has been encountered by the playback control engine in response to the signaling step.

7. The method of claim 1, wherein the playback control engine generates audio signals and video images that are presented to the user in the event that the at least one of the plurality of smaller clips has been completely downloaded.

8. A method for audio and visual content download and playback, comprising:
downloading a clip that includes audio and visual content from a web site, the clip being segmented into a plurality of smaller clips;
storing the metadata for the plurality of smaller clips in a local storage,
initiating playback of the plurality of smaller clips;
displaying the content of a first of the plurality of smaller clips while a second of the plurality of smaller clips is being downloaded.

9. The method of claim 8, additionally comprising a playback control engine receiving a command to playback the second of the plurality of smaller clips.

10. The method of claim 9, additionally comprising the playback control engine signaling to an application the second of the plurality of smaller clips is not accessible.

11. The method of claim 10, additionally comprising:
the application requesting the second of the plurality of smaller clips from the web site.

12. A system for simultaneous audio and visual content presentation and download, comprising:
an application that contacts a web site and identifies and downloads a plurality of content clips along with metadata associated with each of the plurality of content clips; and
local storage that stores metadata corresponding to the plurality of content clips, the local storage being accessed by a playback control engine, wherein
the first of the plurality of smaller clips has been downloaded from the web site, and wherein
the second of the plurality of smaller clips has not been downloaded from the web site.

13. The system of claim 12, wherein the application initiates downloading of the second of the plurality of smaller clips upon receiving a signal from the playback control engine indicating that the second of the plurality of smaller clips is not accessible.

14. The system of claim 12, wherein the metadata includes at least one playlist and a plurality of play items wherein each of the play items corresponds to one of the plurality of smaller clips.

15. The system of claim 14, wherein a storage manager presents a virtual view to the playback control engine, wherein the virtual view includes content stored on an optical storage media, as well as stored in a local storage within the system for simultaneous audio and visual content presentation and download.

16. The system of claim 12, wherein the storage manager presents metadata corresponding to all of the plurality of smaller clips to the playback control engine.

17. An entertainment system that presents audio and visual content, comprising:
means for playing audio and visual content from an optical disc;
means for downloading an audio and visual content file from a web site, the audio and visual content file being segmented into at least a first and second audio and visual clip;
means for downloading metadata corresponding to the at least a first and second audio and visual clip;
means for presenting the first audio and visual clip to a user while downloading the second audio and visual clip.

18. The entertainment system of claim 17, wherein the means for playing audio and visual content from the optical disc includes at least one laser operating at approximately 405 nm.

19. The entertainment system of claim 17, additionally comprising means for presenting metadata corresponding to the first and second audio and visual clips to the means for playing audio and visual content from the optical disc.

20. The entertainment system of claim 17, additionally comprising means for downloading the second audio and visual clip even though the first audio and visual clip has not completed downloading.

21. The entertainment system of claim 17, additionally comprising means for indicating to the user that at least one of the first and second audio and visual clips is in the process of being downloaded.

22. In a content download and playback system, a method for simultaneous content download and playback, comprising:
a user inserting an optical disc that includes audio and visual content;
an application initiating a download of an audio and visual clip from a web site, the audio and visual clip being segmented into at least first and second smaller audio and visual clips; and
the content download and playback system playing to the user the first of the smaller audio and visual clips while the second of the smaller audio and visual clips is downloading from the web site.

23. The method of claim 22, additionally comprising storing metadata in a local storage accessible by a playback control engine of the content download and playback system, the metadata corresponding to the first and the second smaller audio and visual clips.

24. The method of claim 22, additionally comprising:
receiving a command from an application to playback the second of the smaller audio and visual clips; and
indicating to the application that the second smaller audio and visual clip has not been downloaded.
